(19) United States
(12) Patent Application Publication
(10) Pub. No.: US 2021/0318975 A1
(43) Pub. Date: Oct. 14, 2021

(54) Providing I3C Communications Of Multiple Data Lines Via A Universal Serial Bus

(71) Applicant: Intel Corporation, Santa Clara, CA (US)

(72) Inventors: Aruni Nelson, Folsom, CA (US); Abdul Ismail, Beaverton, OR (US); John Howard, Hillsboro, OR (US)

(21) Appl. No.: 17/356,595

(22) Filed: Jun. 24, 2021

(51) Int. Cl. G06F 13/38; G06F 13/42; G06F 13/40

(52) U.S. Cl. CPC G06F 13/385; G06F 13/409; G06F 13/4068; G06F 13/4291

(57) ABSTRACT

In one embodiment, an apparatus includes: a converter to receive and convert single-ended data to differential data, and receive and convert a single-ended clock signal to a differential clock signal; a multiplexer coupled to the converter to receive the differential data and the differential clock signal; and a controller coupled to the multiplexer. In response to an indication that a device coupled to the apparatus is capable of an alternate mode, the controller is to configure the multiplexer to send the differential data on at least one of a plurality of differential pairs of data lanes. Other embodiments are described and claimed.

### BACKGROUND

One bus protocol used in many portable systems, especially for connecting sensors and other such devices to a processor, is an I3C communication protocol in accordance with a MIPI I3C specification such as the MIPI I3C Specification version 1.1 (December 2019) (generally I3C specification), published by MIPI Alliance Inc. The I3C specification currently defines an I3C Single Data Rate (SDR) option having a two wire serial interface that can communicate at up to 12.5 megabits per second (Mbps) along a bus that has one serial clock line (SCL) and one serial data line (SDA)). This I3C specification also provides a High Data Rate (HDR) option with 5 serial interfaces, for communication at up to approximately 100 Mbps (with 1 SCL and up to 4 SDA lines).

Another bus protocol, Universal Serial Bus (USB), with its USB Type-C arrangement supports the SDR and HDR modes by carrying one I3C SCL and one I3C SDA line through a USB Type-C connector. However, there is no support for communicating I3C-based data from multiple SDA lines.

### BRIEF DESCRIPTION OF THE DRAWINGS

FIG. 1 is a block diagram of a portion of an environment that may incorporate an embodiment.

FIG. 2 is a block diagram of another environment in which an embodiment may be used.

FIG. 3 is a block diagram of another environment in which an embodiment may be used.

FIG. 4 is an exemplary pin mapping of a USB Type-C connector for communicating I3C signals in accordance with an embodiment.

FIG. 5 is flow diagram of a method in accordance with an embodiment.

FIG. 6 is a block diagram of a portion of yet another environment that may incorporate an embodiment.

FIG. 7 is an exemplary pin mapping of a USB Type-C connector for communicating SPI signals in accordance with an embodiment.

FIG. 8 is a block diagram of a system in accordance with an embodiment.

### DETAILED DESCRIPTION

In various embodiments, information of one or more protocols may be communicated in part over circuitry and buses of another protocol (e.g., a USB protocol). And more specifically, techniques and circuitry described herein enable communication of I3C data at high speeds (such as HDR mode with multiple data lines) or a future high speed mode. While this is the primary implementation described herein, embodiments may be used to communicate information of other protocols over a USB bus. As one example, data of a Serial Peripheral Interface (SPI) protocol may be communicated in this way.

The techniques described herein include transmitting data using a serial bus protocol such as USB Type-C via a USB receptacle or port, where the data is initially formatted according to a different protocol, e.g., an I3C protocol. More specifically, embodiments may use differential signals of the USB Type-C connector to transparently scale an I3C implementation having multiple SDA lines, as well as increasing SCL frequency beyond a native or base bus speed. As used herein, understand that the term “USB Type-C” refers to implementations of circuitry in accordance with a USB Type-C specification such as USB Type-C Cable and Connector Specification Revision 2.1 (May 27, 2021), or any amendments, updates, future versions, and/or revisions thereto. And in turn, the term “I3C” as used herein refers to implementations of circuitry in accordance with a MIPI I3C Specification version 1.1 (December 2019), or any amendments, updates, future versions, and/or revisions thereto.

To this end, embodiments provide a mapping or allocation of USB Type-C connector pins for I3C SDA and SCL signaling. In addition, bandwidth of multiple SDA lines can be aggregated using a USB lane (e.g., Tx/Rx) using time multiplexing or other mechanisms such as frequency division multiplexing. Time multiplexing of I3C data (single or multiple SDA) can be handled by hardware or firmware/software, which packetizes/depacketizes I3C data to/from USB packets to transmit over USB Type-C connection. For example when using USB4 tunneling, I3C data can be packetized/depacketized to/from USB4 tunneled packets by custom I3C adapters and time multiplexed with other USB4 tunneled protocols. Similarly, hardware (possibly in connection with firmware and/or software) can use frequency division multiplexing to route I3C data packetized into USB format to allocate available USB bandwidth for I3C data.

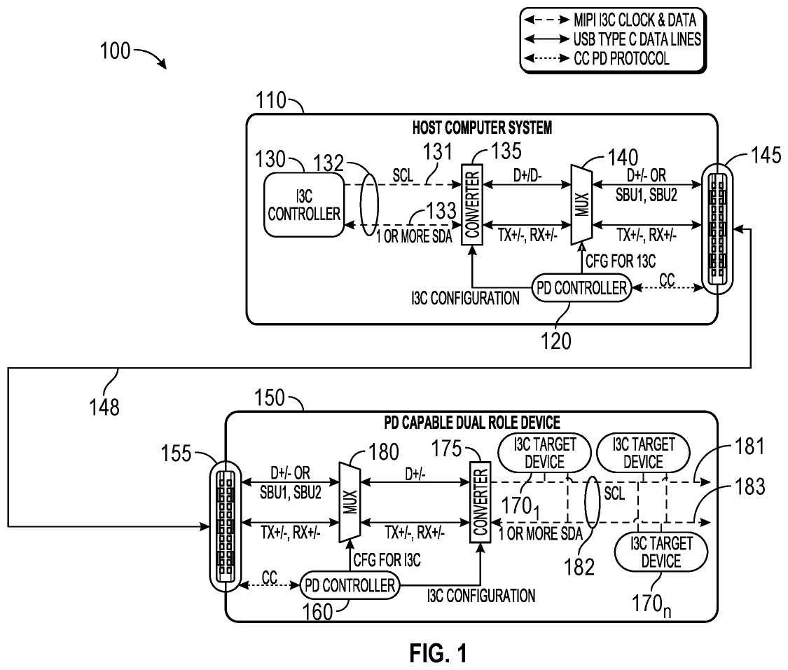

Referring now to FIG. 1, shown is a block diagram of a portion of an environment 100 that may incorporate an embodiment. As shown in FIG. 1, environment 100 may be any type of computer system, ranging from small portable devices such as smartphones, tablet computers, laptop computers and so forth, to larger systems such as desktops or server systems, as examples. In any event, in FIG. 1, environment 100 includes a host computer system 110 that has a capability to operate in USB Type-C alternate modes and other alternate modes. Particular embodiments herein are more specifically directed to systems that are capable of operating in an I3C alternate mode in which data and other information may be communicated across USB Type-C circuitry according to an I3C communication protocol. In the high level of FIG. 1, understand that a limited number of components of host computer system 110 are shown.

Still with reference to FIG. 1, host computer system 110 couples to a device 150 which as shown is a PD capable dual role device via a USB Type-C cable 148. Understand that device 150 may be any type of device such as an augmented reality/virtual reality (ARVR) headset, sensor system, computing accelerator, peripheral device or any other such device, including, as examples, camera, touchscreen, automotive device, interface to memory, or a debug target (such as another host system). Understand that device 150 may further be capable of operating in an alternate mode, including an I3C alternate mode as described herein. In the high level of FIG. 1, understand that a limited number of components of device 150 are shown.

In an embodiment, a USB Type-C I3C Alternate Mode in accordance with an embodiment may be detected through a USB power delivery (PD) negotiation. Such negotiation may occur in response to connection of a PD capable USB device to a host device that supports I3C alternate mode. Via this negotiation, this I3C alternate mode and the I3C capabilities of the USB device may be discovered, at least in part using a Standard or Vendor ID (SVID) and modes for PD messages to recognize the I3C device's capabilities such as the device's role as an I3C controller and/or target device, I3C clock frequency, and configuration with single or multiple SDA lines.

While this particular implementation is described, understand that embodiments more generally may be used to enhance alternate modes of a USB Type-C or other serial bus to enable communication of information of other protocols at high speeds as described herein.

Still with reference to FIG. 1, host system 110 includes a PD controller 120. In embodiments herein PD controller 120 may perform a discovery communication with a remote link partner to determine capabilities of the remote link partner. As described herein, in response to a determination that the connected device is capable of an I3C alternate mode, PD controller 120 may configure various circuitry of host computer system 110 to enable this alternate mode. More particularly in response to this communication, which may be in the form of a negotiation, PD controller 120 may configure both a multiplexer 140 and a converter 135. Multiplexer 140 may include selection circuitry to enable appropriate routing of information along the correct signal lines based on mode of operation and actual physical connection of a cable to a receptacle 145, namely a USB Type-C receptacle. PD controller 120 may further configure converter 135 to perform single-ended-to-differential conversion and vice versa. In this way, single-ended communications via an I3C bus 132 (including a clock line (SCL) 131 and one or more data lines (SDA) 133) are converted to differential signaling for communication via appropriate lanes of a USB Type-C cable 148, and vice versa.

Still with reference to FIG. 1, host system 110 further includes internal lines, which may be implemented via conductive traces, either present as part of a circuit board or integrated circuit. Specifically, USB-based lines may couple converter 135 and multiplexer 140, and multiplexer 140 and receptacle 145. In addition, configuration information can be communicated on configuration lines, e.g., a configuration channel (CC) coupled between PD controller 120 and receptacle 145 (and via additional configuration control lines from PD controller 120 to converter 135 and multiplexer 140). PD controller 120 configures multiplexer 140 to ensure the Tx/Rx and D+/D− signals are routed appropriately. PD controller 120 also configures converter 135 for the SCL frequency and SDA lines.

To provide for I3C communication, host computer system 110 includes an I3C controller 130 that may generate and communicate a clock signal via clock line 131 and data via data line(s) 133. In operation, I3C controller 130 may be configured, at least in certain operation modes, to be a bus manager. Understand while not shown for ease of illustration in FIG. 1, I3C controller 130 may in turn communicate with additional circuitry of host computer system 110, such as processing circuitry, e.g., SoCs, memories or so forth. In some implementations, I3C controller 130 itself may be configured within a SoC or other integrated circuit.

In embodiments, a negotiation between a PD controller 160 of device 150 and PD controller 120 of host system 110 may occur when device 150 couples to system 110. By way of this negotiation, details of which are described further below, the capabilities of device 150, including its ability to operate in an I3C alternate mode, can be identified. Based on this negotiation, PD controller 160 may appropriately configure different components of device 150, including a multiplexer 180 and a converter 175, which may operate similarly to that discussed above with regard to the multiplexer and converter included in host system 110, such that after a successful PD negotiation, conversion between USB differential signals and I3C single-ended signals occurs.

Still with reference to FIG. 1, device 150 further may include a plurality of I3C devices, namely I3C target devices 1701-170n, which couple to converter 175 via an I3C bus 182 including clock line 181 and one or more data lines 183. After a successful PD negotiation, converter 175 may convert received I3C single-ended signals from target devices 170 to differential form for communication via USB cable 148, and vice versa. Understand while shown with this particular implementation in FIG. 1, embodiments are not limited in this regard.

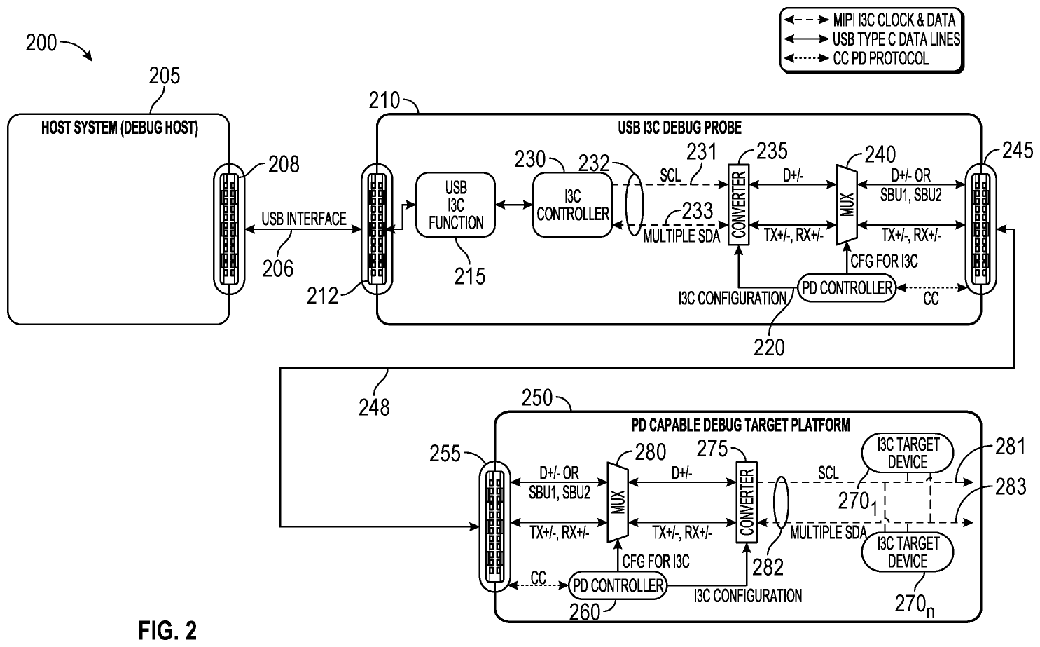

Referring now to FIG. 2, shown is a block diagram of another environment in which an embodiment may be used. More specifically, environment 200 of FIG. 2 is a test environment such as a debug and test system in which a host system 205, namely a debug host, couples to a USB debug probe 210 that may enable I3C alternate modes of operation via a USB interface. In turn, probe 210 couples via a USB Type-C cable 248 to a device 250, namely a PD capable debug target platform that may further be capable of I3C alternate mode operation. Note that certain components in FIG. 2 such as device 150 may be generally similarly configured the same as system 100 of FIG. 1 (and thus reference numerals generally refer to the same components, albeit of the “200” series in place of the “100” series of FIG. 1). In addition, debug probe 210 may be similarly configured (at least partially) the same as the components shown in the view of host device 110 of FIG. 1. In addition to such similar components, debug probe 210 further includes a USB I3C function 215 the enables I3C communications via a receptacle 212 that couples probe 210 to host system 205 via another USB interface 206.

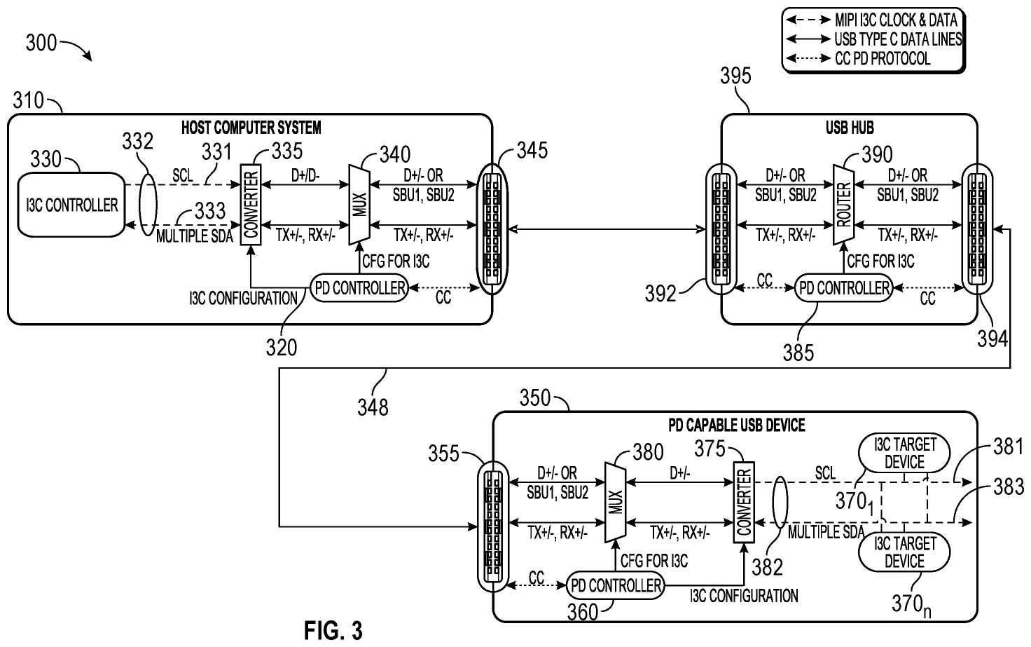

In yet other implementations a USB device may be connected to a host through a hub. Referring now to FIG. 3, shown is a block diagram of another environment in which an embodiment may be used. More specifically, environment 300 of FIG. 3 is an environment in which a USB PD capable device with an I3C alternate mode, namely USB device 350, couples to a host system 310 via a hub 395. As seen, host system 310 and USB device 350 may be configured similarly as corresponding components in environment 100 of FIG. 1 (and thus reference numerals generally refer to the same components, albeit of the “300” series in place of the “100” series of FIG. 1).

As seen, hub 395 includes a router 390 and a PD controller 385, which may operate as described herein to enable communication of USB signaling through receptacles 392, 394. With this arrangement, I3C-based communications can occur via USB Type-C signaling. Understand while shown at this high level in the embodiment of FIG. 3, many variations and alternatives are possible.

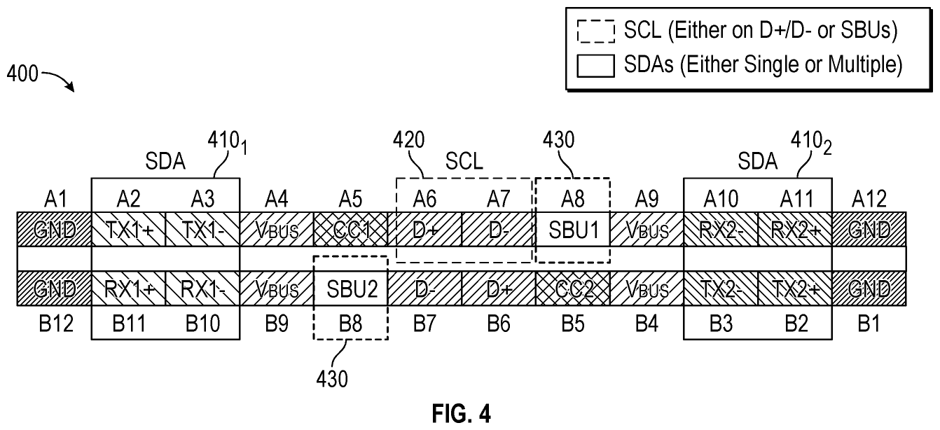

In different implementations, there may be various mappings of USB Type-C connection signals to I3C clock and data signals. Referring now to FIG. 4, shown is one exemplary pin mapping of a USB Type-C connector for communicating I3C signals. More specifically, FIG. 4 shows a USB Type-C receptacle 400 that includes a plurality of pins A1-A12, B1-B12. Note that with a USB Type-C arrangement, an interface may be flippable since there are redundancies of the pins in receptacle 400 (and a corresponding plug that plugs into receptacle 400). Direction of these pins may be handled by a multiplexer, such as shown in the above implementations.

In general, receptacle 400 includes pins for USB 2.0 D+/D-data bus, USB 3.1 transmit/receive (Tx/Rx) differential pairs, along with a configuration channel (CC1, CC2) that is used for cable attach detection, orientation detection, role detection and current mode detection. Cable bus power may be provided via bus pins (Vbus) and a cable ground via ground pins (GND). Furthermore, a pair of sideband use (SBU) pins (SBU1, SBU2) also may be present.

As illustrated in FIG. 4, in one example mapping an I3C clock signal (SCL) may be communicated (differentially) on either a pair of pins 420 (D+/D−) or via pins 430 (namely SBU1 or SBU2 pins). In turn, I3C data (SDA), which may communicate along a single data line or multiple data lines, may be communicated (differentially) via pins 4101 and/or 4102, namely the Tx/Rx differential pairs. Understand while shown with this particular mapping in FIG. 4, alternate mappings are possible.

Thus with embodiments, a USB I3C device can scale to multiple SDAs and higher clock frequencies by leveraging differential signals of a USB Type-C connection and conversion between single-ended and differential signaling. At the same time, the underlying I3C devices and I3C definitions for SDA and SCL communications are unchanged.

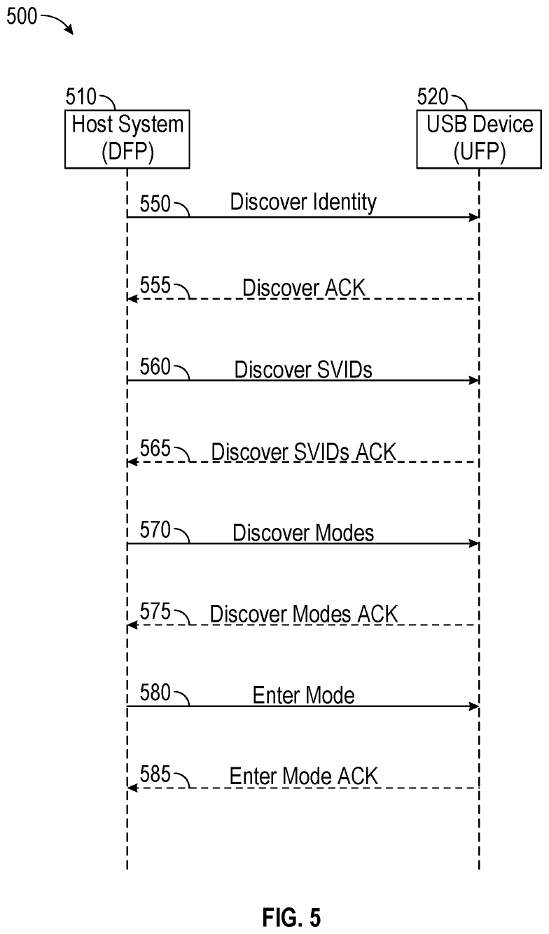

Referring now to FIG. 5, shown is a flow diagram of a negotiation method in accordance with an embodiment. More specifically in FIG. 5, a method 500 may be used to perform a negotiation between a host computing system 510 and a USB device 520, where host system 510 includes a downstream facing port (DFP) and USB device 520 includes an upstream facing port (UFP). With embodiments herein, the negotiation of method 500 may include operations to enable discovery and configuration of USB Type-C alternate modes, including an I3C alternate mode as described herein. In embodiments, method 500 may be performed by hardware circuitry present in these devices, along with firmware, software, and/or combinations thereof.

As illustrated, method 500 begins by the host system issuing a communication to discover an identity of the connected device (block 550). In turn, the USB device acknowledges this discover request (block 555). Via these operations, the host system identifies who the connected device is and the USB device indicates its configuration as a peripheral that has capability for alternate modes of operation.

Still with reference to FIG. 5, next at 560 the host system may issue a request to discover Standard or Vendor IDs (SVIDs) which the USB device acknowledges such that all IDs may be discovered (at 565). Next at 570 the host system seeks discovery of modes of operation including alternate modes. In response, the USB device acknowledges (at 575). In examples, such mode discovery may indicate that the USB device has an I3C device role and can further identify its configuration capabilities, including I3C speeds, and whether data communication is via single or multiple data lines.

Finally, a configuration process may be performed, as shown at 580 and 585 in which the host system issues an enter mode and the USB device acknowledges at 585. In this way, an I3C data path may be configured within USB device 520 based on the enter request from host system 510. This configuration enables entry into an I3C alternate mode and configures the USB device for an I3C device role (e.g., as an I3C controller or I3C target device), as well as configuration parameters including bus speeds and single or multiple data lanes. Understand while shown at this high level in the embodiment of FIG. 5, variations and alternatives are possible.

As discussed above, other implementations may be used to carry signaling information of other protocols over a USB bus. In a particular implementation, a SPI capable device may communicate over a USB link. In some situations, a given device may be capable of multiple alternate modes, including the I3C alternate mode discussed above and an SPI alternate mode. In other cases, a device may be capable of only one of these alternate modes. As used herein the term “SPI” as used herein refers to current implementations of circuitry to communicate serially via a plurality of lines in accordance with Application Note AN991/D (January 2002, Freescale Semiconductors), or any amendments, updates, future versions, and/or revisions thereto, including but not limited to a so-called enhanced SPI (eSPI) protocol in accordance with an Enhanced Serial Peripheral Interface (eSPI) Interface Base Specification version 1.0 ((January 2016) available from Intel Corporation), or any amendments, updates, future versions, and/or revisions thereto.

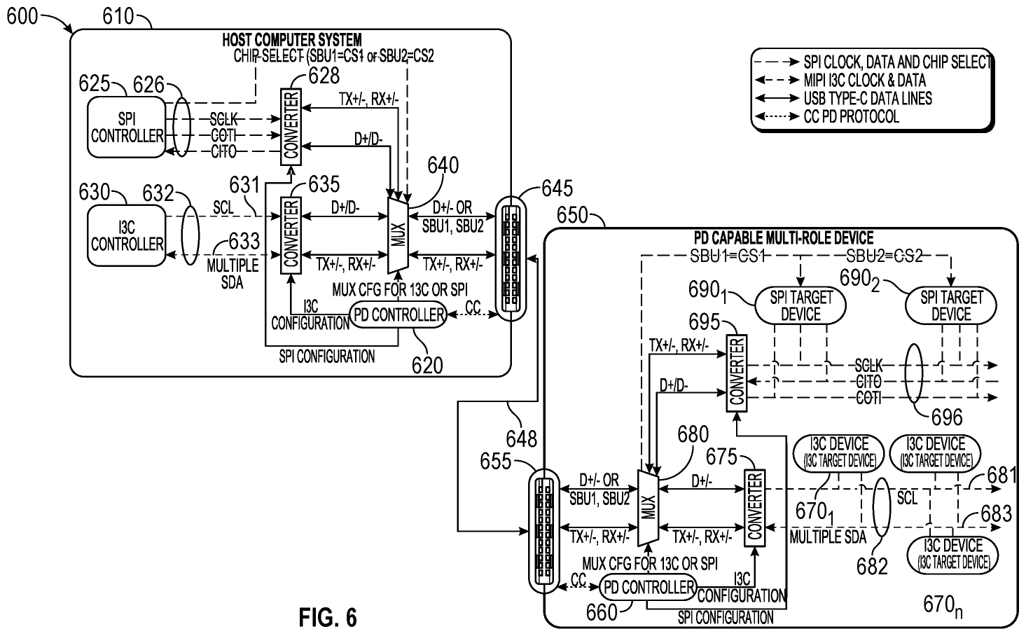

Referring now to FIG. 6, shown is a block diagram of a portion of an environment 600 that may incorporate an embodiment. Note that in the environment of FIG. 6, a host computer system 610 may generally take the same form of host computer system 110 of FIG. 1 (and thus reference numerals generally refer to the same components, albeit of the “600” series in place of the “100” series of FIG. 1). In this implementation however, host computer system 610 further includes an SPI controller 625 that may communicate via an SPI bus 626. As shown. SPI bus 626 has four serial lines, including a chip select line, a clock line (SCLK), an output line controller out/target in (COTI) line, and controller in/target out (CITO) line. At least some lines of SPI bus 626 couple to a converter 628 that further couples to a multiplexer 640.

As further shown, a PD controller 620 may configure converter 628. In the embodiment of FIG. 6, converter 628 may be configured to convert serial information to differential information (more specifically, converter 628 may be used to perform differential signal encoding/decoding to/from SPI-single ended CITO and COTI signaling, and optionally one or more of SCLK, CS signaling). Note that this SPI alternate mode can be identified and discovered via USB PD messages using Standard or Vendor ID (SVID) and modes for PD messages to recognize the SPI capabilities of this device. Note that such negotiation may occur as described above in FIG. 5. In other aspects, host computer system 610 may be configured the same as host computer system 110 of FIG. 1.

In the embodiment shown in FIG. 6, note that CS signaling is sent single-ended via a given SBU pin and thus can bypass converter 628. In another implementation both SCLK and CS can be routed via SBU1 and SBU2 pins and thus bypass converter 628. In the FIG. 6 implementation, with CS signaling (only) routed via SBU pins, there can be two SPI target devices (i.e., CS1 on SBU1 and CS2 on SBU2). However by using a time multiplexing mechanism, multiple targets can be targeted without having a limitation on USB Type-C pins.

Similarly, device 650, which is a PD capable multi-role device, may be configured similarly to device 150 of FIG. 1, with the addition of one or more SPI target devices 190_{1,2} that couple to a converter 695, which may operate similarly to converter 628. With this arrangement, SPI data can be routed via differential signaling of a USB Type-C connection, namely a USB cable 648.

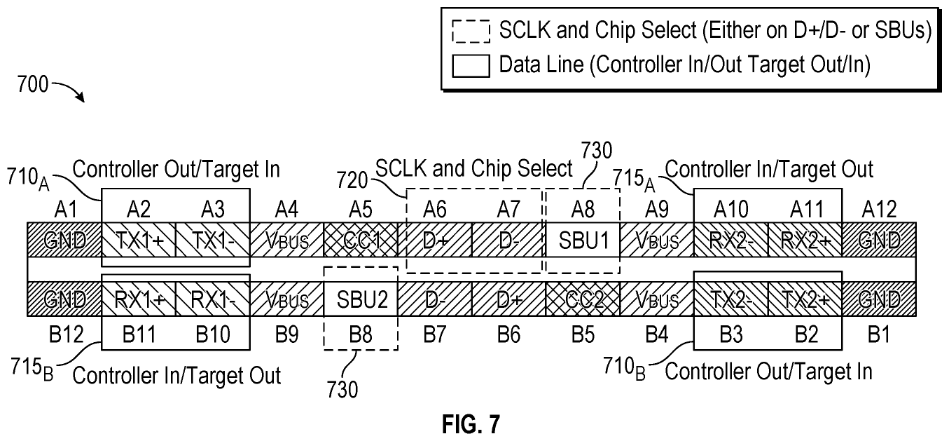

Referring now to FIG. 7, shown is an exemplary pin mapping of a USB Type-C connector for communicating SPI signals. As with the mapping shown in FIG. 4 discussed above, a USB Type-C receptacle 700 includes pins A1-A12, B1-B12.

In this embodiment, COTI signaling may be communicated differentially along Tx differential pairs, via pins 710A, 710s. Similarly, CITO signaling may be communicated differentially along Rx differential pairs, via pins 715A, 715s. As further shown, SCLK may be sent differentially via pins 720 (D+/D−). In turn, chip select signals may be sent single-ended via pins 730 (namely SBU1 and SBU2). Of course while shown with this particular mapping in FIG. 7, alternate mappings are also possible.

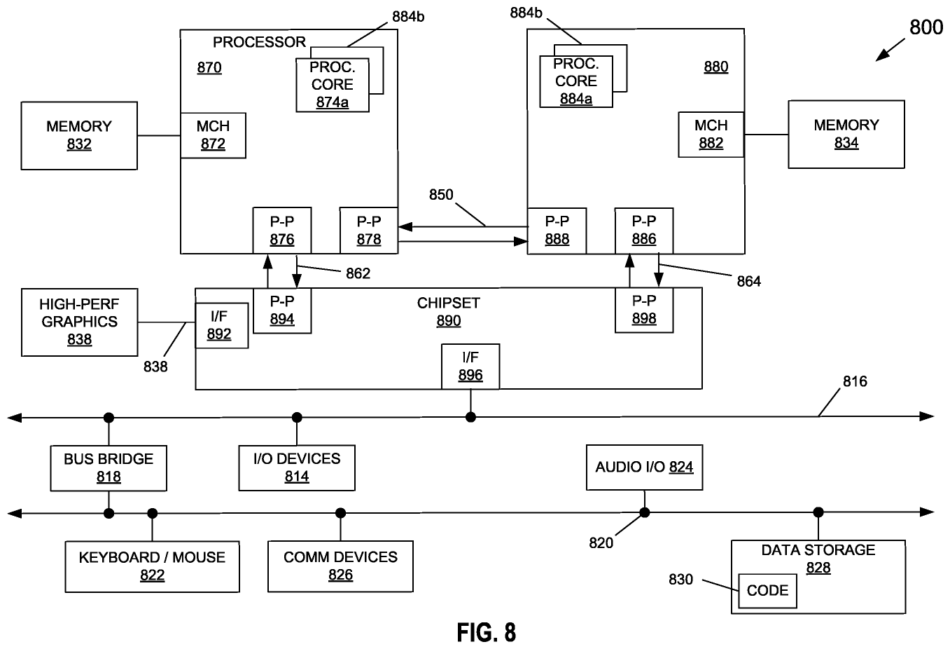

Referring now to FIG. 8, shown is a block diagram of a system in accordance with an embodiment. As shown in FIG. 8, multiprocessor system 800 includes a first processor 870 and a second processor 880 coupled via a point-to-point interconnect 850. As shown in FIG. 8, each of processors 870 and 880 may be many core processors including representative first and second processor cores (i.e., processor cores 874a and 874b and processor cores 884a and 884b).

Still referring to FIG. 8, first processor 870 further includes a memory controller hub (MCH) 872 and point-to-point (P-P) interfaces 876 and 878. Similarly, second processor 880 includes a MCH 882 and P-P interfaces 886 and 888. As shown in FIG. 8, MCH's 872 and 882 couple the processors to respective memories, namely a memory 832 and a memory 834, which may be portions of system memory (e.g., DRAM) locally attached to the respective processors. First processor 870 and second processor 880 may be coupled to a chipset 890 via P-P interconnects 862 and 864, respectively. As shown in FIG. 8, chipset 890 includes P-P interfaces 894 and 898.

Furthermore, chipset 890 includes an interface 892 to couple chipset 890 with a high performance graphics engine 838, by a P-P interconnect 839. As shown in FIG. 8, various input/output (I/O) devices 814 may be coupled to first bus 816, along with a bus bridge 818 which couples first bus 816 to a second bus 820. Note that one or more of the I/O devices may be have USB and I3C and/or SPI functionality such that I3C and/or SPI information may be communicated differentially using a USB Type-C interconnect operating in an alternate mode as described herein. Various devices may be coupled to second bus 820 including, for example, a keyboard/mouse 822, communication devices 826 and a data storage unit 828 such as a disk drive or other mass storage device which may include code 830, in one embodiment. Further, an audio 1/O 824 may be coupled to second bus 820.

The following examples pertain to further embodiments.

In one example, an apparatus comprises: a converter to receive and convert single-ended data to differential data, and receive and convert a single-ended clock signal to a differential clock signal; a multiplexer coupled to the converter to receive the differential data and the differential clock signal; and a controller coupled to the multiplexer, where based at least in part on an indication that a device coupled to the apparatus is capable of an alternate mode, the controller is to configure the multiplexer to send the differential data to the device on at least one of a plurality of differential pairs of data lanes.

In an example, the apparatus further comprises an I3C controller to provide the single-ended data and the single-ended clock signal to the converter.

In an example, the converter is adapted on a motherboard, and the I3C controller is adapted within an integrated circuit coupled to the motherboard.

In an example, the I3C controller is to send the single-ended clock signal and the single-ended data at a frequency greater than a natural I3C bus frequency.

In an example, the converter is to concurrently convert a plurality of single-ended data to a plurality of differential data, the converter to receive the plurality of single-ended data via a plurality of data lines of an I3C bus coupled between the converter and the I3C controller.

In an example, the multiplexer is to send the differential data to the device via a USB interconnect coupled between the apparatus and the device.

In an example, the multiplexer is to send the differential clock signal to the device via the USB interconnect.

In an example, the apparatus is to: send the differential clock signal to the device via a plurality of sideband use lines of the USB interconnect; and send the differential data to the device via a plurality of configurable pairs of lines of the USB interconnect.

In an example, the multiplexer is to send the differential data to the device via a USB Type-C interconnect coupled between the apparatus and the device, where the differential data is of an I3C communication protocol.

In an example, the controller comprises a USB Type-C PD controller to perform a negotiation with the device to identify that the device is capable of the alternate mode, the alternate mode comprising a SPI mode, where the controller is further to configure the multiplexer to send at least one chip select signal to the device via at least one sideband use line of a USB interconnect.

In another example, a method comprises: initiating a negotiation with a host system coupled to a device via a USB link; during the negotiation, indicating that the device is capable of an alternate mode in which data of a plurality of SDA lines of an I3C bus is to be communicated via the USB link; receiving first configuration information from the host system and in response to the first configuration information, configuring a converter of the device to perform single-ended-to-differential conversion of the data communicated on at least one of the plurality of SDA lines; and receiving second configuration information from the host system and in response to the second configuration information, configuring the converter to perform differential-to-single-ended conversion to provide a SCL for communication on a SCL line of the I3C bus.

In an example, the method further comprises causing the device to receive a differential clock signal via the USB link, convert the differential clock signal to the SCL and direct the SCL for the communication on the SCL line of the I3C bus.

In an example, the method further comprises causing the device to convert the data to differential data and direct the differential data to the host system via the USB link.

In an example, the method further comprises causing the device to send the differential data to the host system via the USB link at a first bus speed, the first bus speed greater than a native bus speed of the I3C bus.

In an example, the method further comprises causing the device to receive second differential data from the host system via the USB link, convert the second differential data to second single-ended data and send the second single-ended data to an I3C controller via the plurality of SDA lines.

In yet another example, a device comprises: a converter to receive and convert single-ended data to differential data; a multiplexer coupled to the converter to receive the differential data; and a controller coupled to the multiplexer. Based at least in part on a negotiation between the device and a host system, the controller is to: configure the converter to convert the single-ended data to the differential data, where the converter is to receive the single-ended data via a SPI; and configure the multiplexer to send the differential data on a first transmit/receive pair of a USB link that couples the device to the host system.

In an example, the device comprises a debug probe coupled between the host system and a second device.

In an example, the device further comprises at least one SPI target device, and where: the multiplexer is to receive a differential clock signal from the host system and send the differential clock signal to the converter; and the converter is to convert the differential clock signal to a single-ended clock signal and send the single-ended clock signal to the at least one SPI target device.

In an example, the device further comprises: at least one I3C device; and the controller comprises a USB power delivery controller to perform the negotiation with the host system to communicate at least one of I3C data and SPI data with the host system via the USB link.

In an example, based at least in part on the negotiation, the controller is to configure the multiplexer to: send a first chip select signal associated with a first SPI target device on a first sideband use line of the USB link; and send a second chip select signal associated with a second SPI target device on a second sideband use line of the USB link.

In a still further example, a method comprises: initiating, via a USB PD controller of a host system, a negotiation with a device coupled to the host system via a USB link; during the negotiation, determining that the device is capable of an alternate mode in which SPI data is to be communicated via the USB link; sending first configuration information to the device to cause the device to configure a converter to perform single-ended-to-differential conversion of the SPI data to differential SPI data; and sending second configuration information to the device to cause the device to configure a multiplexer to direct the differential SPI data to the host system via a first transmit pair of the USB link.

In an example, the method further comprises: sending third configuration information to the device to cause the device to configure the converter to perform differential-to-single-ended conversion of a differential clock received from the host system to a serial clock; and sending fourth configuration information to the device to cause the device to configure the multiplexer to direct the differential clock received from the host system via a first data pair of the USB link to the converter.

In an example, the method further comprises: sending fifth configuration information to the device to cause the device to configure the multiplexer to direct at least one chip select signal to the host system via at least one sideband use line of the USB link.

In an example, the method further comprises: receiving the differential SPI data from the device via the USB link; converting the differential SPI data to the SPI data; and forwarding the SPI data to a SPI controller of the host system.

In an example, the method further comprises during a second negotiation with a second device coupled to the host system via the USB link: determining that the second device is capable of another alternate mode in which I3C data is to be communicated via the USB link; sending third configuration information to the second device to cause the second device to configure a second converter to perform single-ended-to-differential conversion of I3C data communicated on a plurality of SDA lines of an I3C bus to differential I3C data; and sending fourth configuration information to the second device to cause the second device to configure a second multiplexer to direct the differential I3C data to the host system via a second transmit pair of the USB link.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In yet another example, a system comprises: a host system comprising at least one processor and an interface to communicate information to a first device coupled to the host system via a USB link; and the first device coupled to the host system via the USB link. The first device comprises: a converter to receive and convert single-ended data to differential data; a multiplexer coupled to the converter to receive the differential data; and a controller coupled to the multiplexer. Based at least in part on a negotiation between the host system and the first device, the controller is to: configure the converter to convert a first set of single-ended data to a first set of differential data, where the converter is to receive each of the first set of single-ended data on one of a plurality of data lines; and configure the multiplexer to send the first set of single-ended data on a plurality of transmit/receive pairs of the USB link.

In an example, the system further comprises a debug probe coupled between the host system and the first device, where the debug probe comprises: a second converter to receive and convert single-ended data to differential data; and a second multiplexer to receive and direct the differential data to the first device via the plurality of transmit/receive pairs.

In an example, the second converter is further to receive and convert a single-ended clock signal to a differential clock signal, and the second multiplexer is to receive and direct the differential clock signal to the first device via a pair of data lines of the USB link.

In an example, the debug probe comprises an I3C controller to provide the single-ended data to the second converter, and the I3C controller is to send the single-ended data to the second converter at a frequency greater than a natural I3C bus frequency.

In an example, based at least in part on another negotiation between the host system and the first device, the controller is to: configure the converter to convert second single-ended data to second differential data and convert a single-ended clock signal to a differential clock signal; and configure the multiplexer to send the second differential data on one of the plurality of transmit/receive pairs of the USB link, send the differential clock signal on a pair of data lines of the USB link, and send at least one chip select signal on at least one sideband use line of the USB link.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
a converter to receive and convert single-ended data to differential data, and receive and convert a single-ended clock signal to a differential clock signal;
a multiplexer coupled to the converter to receive the differential data and the differential clock signal; and
a controller coupled to the multiplexer, wherein based at least in part on an indication that a device coupled to the apparatus is capable of an alternate mode, the controller is to configure the multiplexer to send the differential data to the device on at least one of a plurality of differential pairs of data lanes.

2. The apparatus of claim 1, further comprising an I3C controller to provide the single-ended data and the single-ended clock signal to the converter.

3. The apparatus of claim 2, wherein the converter is adapted on a motherboard, and the I3C controller is adapted within an integrated circuit coupled to the motherboard.

4. The apparatus of claim 2, wherein the I3C controller is to send the single-ended clock signal and the single-ended data at a frequency greater than a natural I3C bus frequency.

5. The apparatus of claim 2, wherein the converter is to concurrently convert a plurality of single-ended data to a plurality of differential data, the converter to receive the plurality of single-ended data via a plurality of data lines of an I3C bus coupled between the converter and the I3C controller.

6. The apparatus of claim 2, wherein the multiplexer is to send the differential data to the device via a Universal Serial Bus (USB) interconnect coupled between the apparatus and the device.

7. The apparatus of claim 6, wherein the multiplexer is to send the differential clock signal to the device via the USB interconnect.

8. The apparatus of claim 7, wherein the apparatus is to:
send the differential clock signal to the device via a plurality of sideband use lines of the USB interconnect; and
send the differential data to the device via a plurality of configurable pairs of lines of the USB interconnect.

9. The apparatus of claim 1, wherein the multiplexer is to send the differential data to the device via a Universal Serial Bus (USB) Type-C interconnect coupled between the apparatus and the device, wherein the differential data is of an I3C communication protocol.

10. The apparatus of claim 1, wherein the controller comprises a Universal Serial Bus (USB) Type-C power delivery (PD) controller to perform a negotiation with the device to identify that the device is capable of the alternate mode, the alternate mode comprising a Serial Peripheral Interface (SPI) mode, wherein the controller is further to configure the multiplexer to send at least one chip select signal to the device via at least one sideband use line of a USB interconnect.

11. A computer readable medium comprising instructions that, when executed, enable a device to:
initiate a negotiation with a host system coupled to the device via a Universal Serial Bus (USB) link;
during the negotiation, indicate that the device is capable of an alternate mode in which data of a plurality of serial data (SDA) lines of an I3C bus is to be communicated via the USB link;
receive first configuration information from the host system and in response to the first configuration information, configure a converter of the device to perform single-ended-to-differential conversion of the data communicated on at least one of the plurality of SDA lines; and
receive second configuration information from the host system and in response to the second configuration information, configure the converter to perform differential-to-single-ended conversion to provide a serial clock signal (SCL) for communication on a SCL line of the I3C bus.

12. The computer readable medium of claim 11, further comprising instructions that, when executed, cause the device to receive a differential clock signal via the USB link, convert the differential clock signal to the SCL and direct the SCL for the communication on the SCL line of the I3C bus.

13. The computer readable medium of claim 11, further comprising instructions that, when executed, cause the device to convert the data to differential data and direct the differential data to the host system via the USB link.

14. The computer readable medium of claim 13, further comprising instructions that, when executed, cause the device to send the differential data to the host system via the USB link at a first bus speed, the first bus speed greater than a native bus speed of the I3C bus.

15. The computer readable medium of claim 11, further comprising instructions that, when executed, cause the device to receive second differential data from the host system via the USB link, convert the second differential data to second single-ended data and send the second single-ended data to an I3C controller via the plurality of SDA lines.

16. A device comprising:
a converter to receive and convert single-ended data to differential data;
a multiplexer coupled to the converter to receive the differential data; and
a controller coupled to the multiplexer, wherein based at least in part on a negotiation between the device and a host system, the controller is to:
configure the converter to convert the single-ended data to the differential data, wherein the converter is to receive the single-ended data via a Serial Peripheral Interface (SPI); and
configure the multiplexer to send the differential data on a first transmit/receive pair of a Universal Serial Bus (USB) link that couples the device to the host system.

17. The device of claim 16, wherein the device comprises a debug probe coupled between the host system and a second device.

18. The device of claim 16, wherein the device further comprises at least one SPI target device, and wherein:
the multiplexer is to receive a differential clock signal from the host system and send the differential clock signal to the converter; and
the converter is to convert the differential clock signal to a single-ended clock signal and send the single-ended clock signal to the at least one SPI target device.

19. The device of claim 18, wherein the device further comprises:
at least one I3C device; and
the controller comprises a USB power delivery controller to perform the negotiation with the host system to communicate at least one of I3C data and SPI data with the host system via the USB link.

20. The device of claim 16, wherein based at least in part on the negotiation, the controller is to configure the multiplexer to:
send a first chip select signal associated with a first SPI target device on a first sideband use line of the USB link; and
send a second chip select signal associated with a second SPI target device on a second sideband use line of the USB link.

21. A method comprising:
initiating, via a Universal Serial Bus (USB) power delivery (PD) controller of a host system, a negotiation with a device coupled to the host system via a USB link;
during the negotiation, determining that the device is capable of an alternate mode in which Serial Peripheral Interface (SPI) data is to be communicated via the USB link;
sending first configuration information to the device to cause the device to configure a converter to perform single-ended-to-differential conversion of the SPI data to differential SPI data; and
sending second configuration information to the device to cause the device to configure a multiplexer to direct the differential SPI data to the host system via a first transmit pair of the USB link.

22. The method of claim 21, further comprising:
sending third configuration information to the device to cause the device to configure the converter to perform differential-to-single-ended conversion of a differential clock received from the host system to a serial clock; and
sending fourth configuration information to the device to cause the device to configure the multiplexer to direct the differential clock received from the host system via a first data pair of the USB link to the converter.

23. The method of claim 21, further comprising:
sending fifth configuration information to the device to cause the device to configure the multiplexer to direct at least one chip select signal to the host system via at least one sideband use line of the USB link.

24. The method of claim 21, further comprising:
receiving the differential SPI data from the device via the USB link;
converting the differential SPI data to the SPI data; and
forwarding the SPI data to a SPI controller of the host system.

25. The method of claim 21, further comprising during a second negotiation with a second device coupled to the host system via the USB link:
determining that the second device is capable of another alternate mode in which I3C data is to be communicated via the USB link;
sending third configuration information to the second device to cause the second device to configure a second converter to perform single-ended-to-differential conversion of I3C data communicated on a plurality of serial data (SDA) lines of an I3C bus, to differential I3C data; and
sending fourth configuration information to the second device to cause the second device to configure a second multiplexer to direct the differential I3C data to the host system via a second transmit pair of the USB link.
